(19) United States
(12) Patent Application Publication
(10) Pub. No.: US 2022/0305599 A1
(43) Pub. Date: Sep. 29, 2022

(54) DEVICE FOR MOVING A TREATMENT HEAD AND A TRAY

(71) Applicant: HYDROPROCESS, CHALON SUR SAONE (FR)

(72) Inventor: Philippe DEREIMS, CHALON SUR SAONE (FR)

(73) Assignee: HYDROPROCESS, CHALON SUR SAONE (FR)

(21) Appl. No.: 17/616,819

(22) PCT Filed: Jun. 10, 2020
(86) PCT No.: PCT/EP2020/066131

§ 371 Date: Dec. 6, 2021

(30) Foreign Application Priority Data
Jun. 12, 2019 (FR) FR1906250

(51) Int. Cl. B23Q 1/62; B23Q 1/56

(52) U.S. Cl. CPC B23Q 1/621; B23Q 1/56; B23K 26/08

(57) ABSTRACT

A device (I) for moving a treatment head (JO) and a tray (20) in relation to a plane P., The tray (20) of any shape is inscribed within a rectangle of width A and length 0.8., and includes a first driver (21) suitable for cooperating with a first actuator (22) so as to move the tray (20) in translation within a plane that is parallel to said plane .P. in a movement zone (30) formed from at least two perpendicular edges associated with a reference frame, Q, y, in a direction that is normally parallel to one of said axes or y, the device. (I) The device includes at least: a mobile arm (11) of length R pivotably mounted on one of its ends about an axis £ that is perpendicular to said plane .P., set in motion by a second actuator.

### TECHNICAL FIELD

The present invention generally relates to a device for moving a treatment head and a tray and more particularly to a device for moving a cutting head and a tray, of simple design, easily cleanable, compact and intended for cutting food products.

### PRIOR ART

In the field of devices for moving a food cutting head, devices for moving a water jet cutting head are well known, consisting of a support on which a telescopic arm is articulated. This arm is generally provided with carriages capable of moving on rails by means of actuating means allowing its movement in the rectangular directions x and y. It also regularly includes, at one of its ends, a height-adjustable cutting nozzle (along capable of sweeping an often fixed cutting tray intended to support a sample. For example, this type of support is found in the French patent application FR2938463.

The disadvantages of these devices lie in the fact that they have a complex structure (telescopic arm made up of carriages and rails, . . . ), which makes them difficult to be installed and increases manufacturing costs.

In addition, these structures made up of several members multiply the number of available recesses, which affects the cleanability of the device. Indeed, when cutting a food product, fine particles are projected around the product and are deposited in particular on the cutting members (rails, carriages, etc.). These depositions lead, in the food sector in particular, to a need for very frequent cleaning in order to limit the risk of bacteria appearing and consequently generate a significant loss of time and money. Moreover, since the tray is fixed, the arm, in order to perform certain cuts, must perform large amplitude movements which increases the area of the cutting zone and increases the space requirement of the machine.

To partially overcome these disadvantages, movement devices driving a tray and a water jet cutting head in perpendicular rectilinear directions are well known. This type of device has better cleanability and limits the risks of contamination, in particular of the lower faces of the cut products, thanks to a narrow slot located under the moving product and allowing the collection of the effluents resulting from the cutting.

However, devices of this type have actuators positioned on the sides of the movement zone, which also tends to increase the space requirement of the machine. Indeed, for a tray of length B and width A, these devices generally have a space requirement greater than 4×A×B.

### PRESENTATION OF THE INVENTION

The purpose of the present invention is therefore to overcome the aforementioned disadvantages by proposing a device for moving a treatment head and a tray in relation to a plane P, wherein said tray of any shape is inscribed within a rectangle of width A and length B, and includes a first driving means suitable for cooperating with a first actuating means so as to move the tray in translation within a plane that is parallel to said plane P in a movement zone formed from at least two perpendicular edges associated with a reference frame x, O, y, in a direction that is normally parallel to one of said axes x or y, said device being remarkable in that it includes at least:

a movable arm of length R, pivotably mounted on one of its ends about an axis c that is perpendicular to said plane P, set in motion by a second actuating means and comprising a treatment head at the other end, said axis c being located in the movement zone of the tray and cutting off said movement zone at point Q, and,

in that the ratio of the area of the movement zone to area of the circumscribed rectangle of the tray is at least equal to 2.

Advantageously, the ratio of the area of the movement zone to area of the circumscribed rectangle of the tray is greater than or equal to 2 but strictly less than 4.

Preferably, the arm is positioned so as to sweep the tray at an open angle in the direction of the axis of movement x or y and the movement zone is a rectangle the area of which is substantially equal to:
for a device whose tray moves in the direction of the axis x, whose point Q is positioned at B/2 along the axis y and whose treatment head is positioned at A along the axis x when it is at the ends of its trajectory:

(2×A+ε)×(B+δ)

wherein, δ represents the space requirement of the first driving means along the axis y and ε the arrow of the trajectory of the treatment head in relation to a vertical straight line positioned at A along the axis x;
for a device whose tray moves in the direction of the axis y, whose point Q is positioned at A/2 along the axis x and whose treatment head is positioned at B along the axis y when it is at the ends of its trajectory:

(2×B+ε)×(A+δ)

wherein, δ̅ represents the space requirement of the first driving means along the axis x̅ and ε the arrow of the trajectory of the treatment head in relation to a vertical straight line positioned at B along the axis y;

Advantageously, the axis c of the movable arm includes a second driving means intended to cooperate with the second actuating means. Preferably, the treatment head is movable in a direction that is normally parallel to the axis c by means of a third actuating means. Advantageously, the second actuating means and the second driving means are respectively an actuator of the geared motor type provided with a toothed sector driving a curved rack fixed to the axis c of the movable arm.

Preferably, the third actuating means is a screw-nut system. Advantageously, the first actuating means and the first driving means are respectively an actuator of the geared motor type provided with a pinion driving a rack fixed to the tray.

Preferably, the tray consists of a frame articulated around a guide element and a central plate so that said frame is retractable, in that the first driving means of the tray is positioned on said frame so that the plate can be removed from said frame and in that δ represents the space requirement of the first driving means and of the guide element along the axis y or x, respectively for a movement of the tray in the direction of the axis x or y.

Advantageously, the treatment head is a head allowing water jet cutting.

Preferably, the movable arm is hollow to accommodate the passage in particular of very high-pressure water and compressed air.

### BRIEF DESCRIPTION OF THE FIGURES

FIG. 1 shows an overview of a water jet cutting machine on which a movement device according to the invention is installed.

FIG. 2 shows a top view of a water jet cutting machine without the upper part of the assembly on which is installed a movement device according to the invention.

FIG. 3 shows a top view of a movement device wherein the tray is moving along the axis x, according to the invention.

FIG. 4 shows a side view of a movement device surrounded by a cover wherein the tray is moving along the axis x, according to the invention.

### DETAILED DESCRIPTION OF THE INVENTION

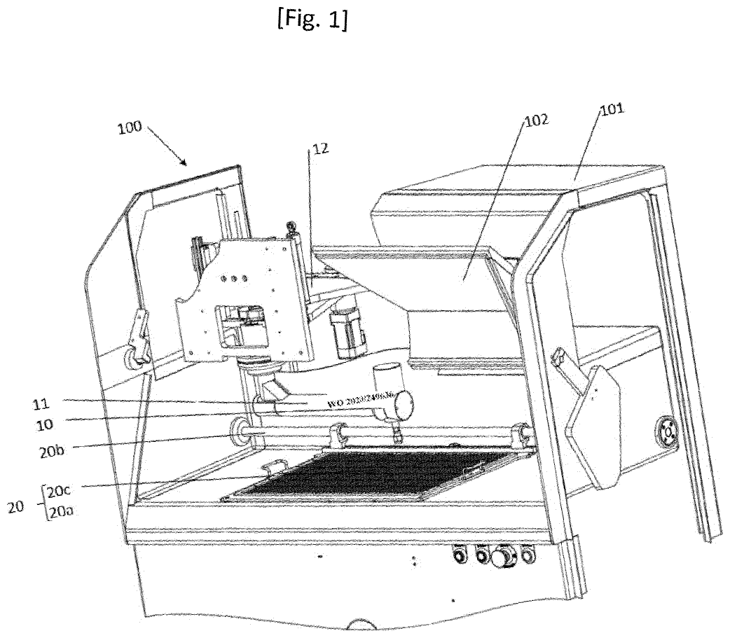

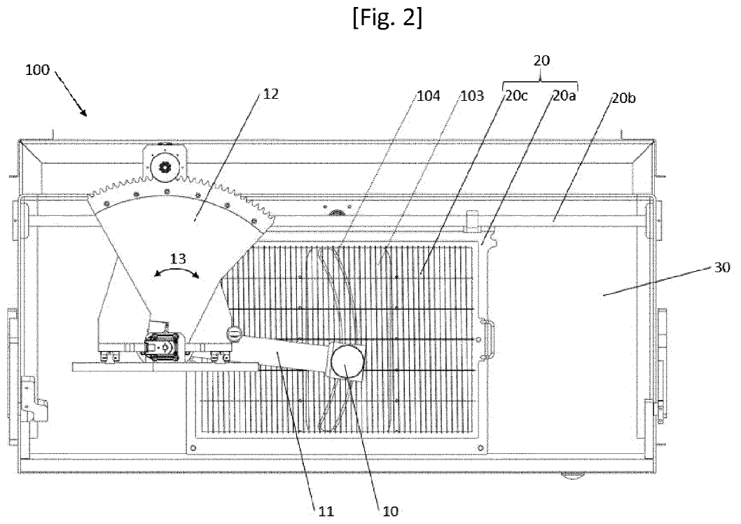

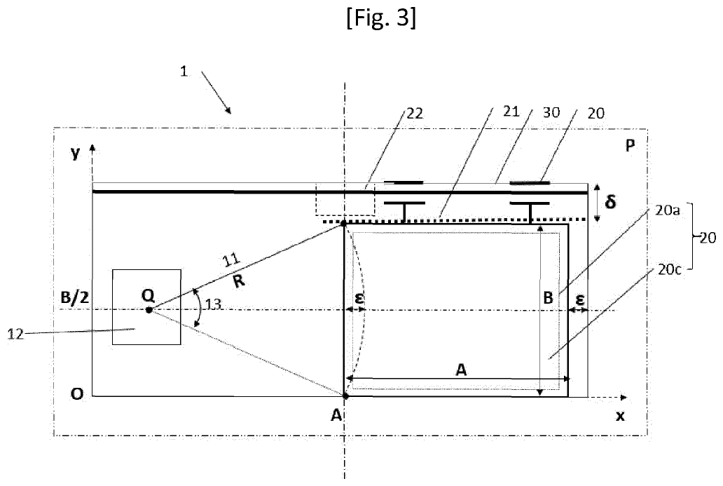

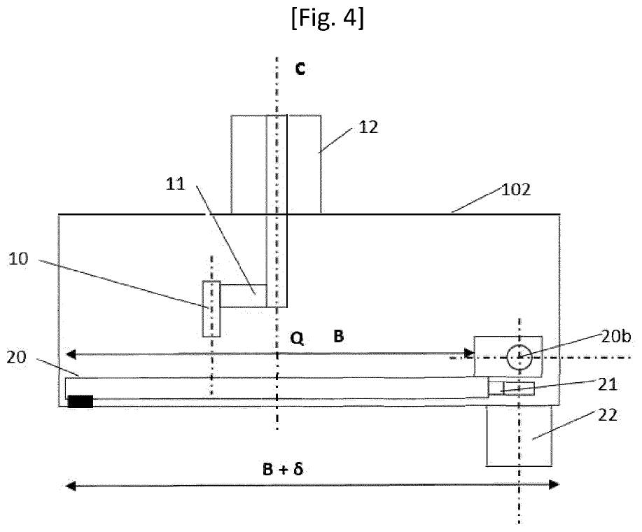

With reference to FIGS. 1 to 4, a device 1 for moving a treatment head 10 and a tray 20 in relation to a plane P is described, wherein said tray 20 of any shape is inscribed within a rectangle of width A and length B, and includes a first driving means 21 suitable for cooperating with a first actuating means 22 so as to move the tray 20 in translation within a plane that is parallel to said plane P in a movement zone 30 formed from at least two perpendicular edges associated with a reference frame x, O, y, in a direction that is normally parallel to one of said axes x or y, said device 1 being remarkable in that it includes at least:

a movable arm 11 of length R, pivotably mounted on one of its ends about an axis c that is perpendicular to said plane P, set in motion by a second actuating means 12 and comprising a treatment head 10 at the other end, said axis c being located in the movement zone 30 of the tray 20 and cutting off said movement zone 30 at point Q, and,

in that the ratio of the area of the movement zone 30 to area of the circumscribed rectangle of the tray 20 is at least equal to 2.

Preferably, the ratio of the area of the movement zone 30 to area of the circumscribed rectangle of the tray 20 is greater than or equal to 2 but strictly less than 4. The tray 20 intended to support the product to be treated (not shown), is advantageously a parallelogram, this shape allowing to optimise the available area. However, it can have any flat shape, such as a triangle, square, circle, etc. Moreover, the plane P wherein the tray 20 moves in translation will be chosen to be normally horizontal. It goes without saying that the movement device 1 can be used in any other position without departing from the scope of the present invention.

Considering the case where the movement device 1 is intended for a water jet cutting machine 100, it will be chosen to manufacture the different parts of this device 1 (arm 11, movement zone 30, tray 20, etc.) from one or more corrosion resistant materials, for example, stainless steel. The term “driving means” 21 of an object refers to the part(s) of this object cooperating directly with the actuating means 12, 22, to set this object in motion.

The term “actuating means” 12, 22 refers to an actuator acting on the driving means 21 of an object to provide the energy necessary for this/these driving means 21 to set the object in motion.

The term “movement zone” 30 refers to the maximum area that the tray 20 travels during its course.

The term “treatment head” 10 refers to any tool allowing to carry out an operation on the product to be treated (not shown), it is thus possible, for example, to have an observation head for analysing the product, a cutting head (laser, water jet cutting head, etc.), a welding head, a machining head (milling . . . ), a gripping head etc. Thus, this movement device 1 can be installed on any type of machine (cutting machine, machining machine, . . . ).

Preferably, the arm 11 is positioned so as to sweep the tray 20 at an open angle 13 in the direction of the axis of movement x or y and the movement zone 30 is a rectangle whose area is substantially equal to:
for a device 1 whose tray 20 moves in the direction of the axis x, whose point Q is positioned at B/2 along the axis y and whose treatment head 10 is positioned at A along the axis x when it is at the ends of its trajectory:

(2×A+ε)×(B+δ)

wherein, δ represents the space requirement of the first driving means 21 along the axis y and ε the arrow of the trajectory of the treatment head 10 in relation to a vertical straight line positioned at A along the axis x;
for a device 1 whose tray 20 moves in the direction of the axis y, whose point Q is positioned at A/2 along the axis x and whose treatment head 10 is positioned at B along the axis y when it is at the ends of its trajectory:

(2×B+ε)×(A+δ)

wherein, δ represents the space requirement of the first driving means 21 along the axis x and ε the arrow of the trajectory of the treatment head 10 in relation to a vertical straight line positioned at B along the axis y;

The movement zone 30 of the tray 20 is thus minimised and the sweeping of the arm 11 is optimised. In this configuration, a scanning angle 13 of the arm 11 allowing to scan the entire length B of the circumscribed rectangle of the tray 20 will be selected.

Advantageously, the axis c of the movable arm 11 includes a second driving means (not shown) intended to cooperate with the second actuating means 12.

Preferably, the treatment head 10 is movable in a direction that is normally parallel to the axis c by means of a third actuating means (not shown). This third actuating means (not shown) will allow the treatment head 10 to be adjusted in height. Thus, the position of the head 10 can be adjusted according, for example, to the thickness of the product to be cut in the case of a cutting head (laser, water jet cutting), to the thickness of the material to be removed from the product to be treated in the case of a machining head (milling) etc.

Advantageously, the second actuating means 12 and the second driving means (not shown) are respectively an actuator of the geared motor type provided with a toothed sector driving a curved rack fixed to the axis c of the movable arm 11. This system allows a faithful repercussion of the movement of the rack on the treatment head 10. The movement of the head 10 is thus controlled precisely. A distance between the pinion axis and the axis c is selected close to the length R of the arm 11 and the opening angle of the toothed sector will correspond to the scanning angle 13 of the treatment head 10. Use can also be made of an electric cylinder as second actuating means 12, and of a connecting rod as second driving means (not shown), said connecting rod will be fixed to the axis c of the arm 11. It can also be imagined that the second actuating means 12 is an actuator of the geared motor or torque motor type. In this case, an electric geared motor with a hollow shaft allowing reversible operation to pivot the arm 11 in one direction or the other with precision around the axis c will be selected. This geared motor will have the advantage of being compact.

Preferably, the third actuating means (not shown) is a screw-nut system.

Advantageously, the first actuating means 22 and the first driving means 21 are respectively an actuator of the geared motor type provided with a pinion driving a rack fixed to the tray 20. The person skilled in the art will have no difficulty to choose the shape and the pitch of the teeth adapted to the precise movement of the tray 20 or of the arm 11 during the rotation of the first actuating means 22 and the second actuating means 12. It is also possible to imagine a first actuating means 22/first driving means 21 couple formed respectively by a linear motor and magnets fixed to the tray 20.

Preferably, the tray 20 consists of a frame 20a articulated around a guide element 20b and a central plate 20c so that said frame 20a is retractable, the first driving means 21 of the tray 20 is positioned on said frame 20a so that the plate (20c) can be removed from said frame 20a and δ represents the space requirement of the first driving means 21 and the guide element 20b along the axis y or x, respectively for a movement of the tray 20 in the direction of the axis x or y. This particular assemblage will allow to remove the plate 20c and thus to facilitate the cleaning of the movement zone 30 of the tray 20. To facilitate the handling of the plate 20c, handles can be added to its ends. The frame 20a will rotate on the guide element 20b so as to be lifted from the cutting zone and to facilitate the cleaning.

Advantageously, the treatment head 10 is a head allowing water jet cutting. In this case, the plate 20c will be a metal grid allowing the collection of the cutting water. The cutting head 10 of this device 1 will be provided with a nozzle supplied with water by a rigid pressurised tube.

Preferably, the movable arm 11 is hollow to accommodate the passage in particular of very high-pressure water and compressed air. The arm 11 and its pivot are hollow and can also accommodate any fluid necessary for the operation of the treatment head 10.

The movement device 1 allows to produce a cutting machine 100 which is compact and easily cleanable. The machine 100 will advantageously include a mechanically-welded metal assembly 101 of generally parallelepiped shape, on which a transparent cover 102 will be articulated allowing the working zone to be sealed off. This cover 102 will preferably be soundproofed, for better comfort of use.

It is understandable that the person skilled in the art will be able, without difficulty, to replace this mechanically welded assembly with an assembly having another structure.

The second actuating means 12 will be placed outside the cutting zone so as to protect it from water and product splash that may occur during cutting.

Generally, all the first, second and third actuating means 22, 12 are located outside the cutting zone.

The cutting machine 100 will include a cutting water collection tank 103 disposed under the cutting tray 20, provided with an outlet on its lower end and a high-pressure pumping system connected to the movable arm 11. The movement zone 30 will include a slot 104 communicating with the collection tank 103, and being positioned under the treatment head 10.

Possibility of industrial application

Finally, it is obvious that the device 1 according to the invention can be adapted to all types of cutting such as, for example, laser cutting, and that the examples which have just been given are only particular illustrations which are in no way limiting as to the field of application according to the invention.

1-10. (canceled)

11. A device for moving a treatment head and a tray in relation to a plane P, wherein said tray of any shape is inscribed within a rectangle of width A and length B, and includes a first driver suitable for cooperating with a first actuator so as to move the tray in translation within a plane that is parallel to said plane P in a movement zone formed from at least two perpendicular edges associated with a reference frame x, O, y, in a direction that is normally parallel to one of said axes x or y, the ratio of the area of the movement zone to area of the circumscribed rectangle of the tray being at least equal to 2, said device comprising:
a movable arm of length R, pivotably mounted on one of its ends about an axis c that is perpendicular to said plane P, set in motion by a second actuator and comprising a treatment head at the other end, said axis c being located in the movement zone of the tray and cutting off said movement zone at point Q.

12. The movement device according to claim 11, wherein the arm is positioned so as to sweep the tray at an open angle in the direction of the axis of movement x or y and in that the movement zone is a rectangle the area of which is substantially equal to:
for a device whose tray moves in the direction of the axis x, whose point Q is positioned at B/2 along the axis y and whose treatment head is positioned at A along the axis x when it is at the ends of its trajectory:
(2×A+ε)×(B+δ)
wherein, δ represents the space requirement of the first driver along the axis y and ε the arrow of the trajectory of the treatment head in relation to a vertical straight line positioned at A along the axis x;
for a device whose tray moves in the direction of the axis y, whose point Q is positioned at A/2 along the axis x and whose treatment head is positioned at B along the axis y when it is at the ends of its trajectory:
(2×B+ε)×(A+δ)
wherein, δ represents the space requirement of the first driver along the axis x and the arrow of the trajectory of the treatment head in relation to a vertical straight line positioned at B along the axis y;

13. The movement device according to claim 11, wherein the axis c of the movable arm includes a second driver intended to cooperate with the second actuator.

14. The movement device according claim 11, wherein the treatment head is movable in a direction that is normally parallel to the axis c by a third actuator.

15. The movement device according to claim 13, wherein the second actuator and the second driver are respectively an actuator of the geared motor type provided with a toothed sector driving a curved rack fixed to the arm.

16. The movement device according to claim 14, wherein the third actuator is a screw-nut system.

17. The movement device according to claim 11, wherein the first actuator and the first driver are respectively an actuator of the geared motor type provided with a pinion driving a rack fixed to the tray.

18. The movement device according to claim 11, wherein the tray includes a frame articulated around a guide element and a central plate so that said frame is retractable, wherein the first driver of the tray is positioned on said frame so that the plate can be removed from said frame and wherein δ represents the space requirement of the first driver and of the guide element along the axis y or x, respectively for a movement of the tray in the direction of the axis x or y.

19. The movement device according to claim 11, wherein the treatment head is a head allowing water jet cutting.

20. The movement device according to claim 19, wherein the movable arm is hollow to accommodate the passage in particular of very high-pressure water and compressed air.
